(19) United States
(12) Patent Application Publication
(10) Pub. No.: US 2025/0323545 A1
(43) Pub. Date: Oct. 16, 2025

(54) Electric Machine with S-Wind Weaveless Design

(71) Applicant: BorgWarner Inc., Auburn Hills, MI (US)

(72) Inventor: Kirk Neet, Noblesville, IN (US)

(21) Appl. No.: 19/176,948

(22) Filed: Apr. 11, 2025

Related U.S. Application Data
(60) Provisional application No. 63/632,984, filed on Apr. 11, 2024.

(51) Int. Cl. H02K 3/28; H02K 1/16; H02K 15/065

(52) U.S. Cl. CPC H02K 3/28; H02K 1/16; H02K 15/065; H02K 2203/06

(57) ABSTRACT

A stator for an electric machine is disclosed herein. In at least one embodiment, the stator comprises a stator core including a plurality of teeth with slots formed between the teeth. A winding arrangement is positioned on the stator core and includes a plurality of conductors forming a multi-phase winding. Each phase of the multi-phase winding includes a plurality of parallel paths arranged in the slots with the winding defined by at least four slots-per-pole-per-phase. The plurality of parallel paths include a first plurality of adjacent paths and a second plurality of adjacent paths, wherein the winding is weaveless and void of any weave between the first plurality of adjacent paths and the second plurality of adjacent paths. Start leads and finish leads for the plurality of parallel paths are all positioned on a same half of the stator core.

### CROSS-REFERENCE TO RELATED APPLICATIONS

This application claims priority from U.S. Provisional Patent Application No. 63/632,984, filed Apr. 11, 2024, the entire contents of which are incorporated by reference herein.

### FIELD

This application relates to the field of electric motors and particularly to winding arrangements for stators.

### BACKGROUND

Electric machines typically include a winding arrangement positioned on a stator core and a rotor that is configured to rotate within the stator. One typical winding arrangement is an S-wind configuration wherein continuous conductors are wound through slots on the stator core with end-turns on alternating ends of the stator core. Prior cascade machines with S-winding arrangements have required a primary weave and a secondary weave to balance the winding arrangement. A balanced winding is critical to prevent recirculating currents in the stator during operation. A stator with excessive recirculating currents will have high losses and consequently low efficiency. In order to balance a winding, the average layer of each parallel path should be the same or similar to the other parallel paths. Layers are defined as the radial position of the conductor in the slot. Cascade windings are defined as a winding arrangement wherein most end loops connect a wire segment located in a layer to another wire segment located in a different slot, but in the same layer. One problem with the current method to balance an s-winding is the weaving process is difficult and expensive.

In view of the foregoing, it would be advantageous to provide an S-winding arrangement for a stator that is easier to manufacture than conventional S-winding arrangements. It would be of further advantage if the winding arrangement could be formed on the stator core with relative ease and without a substantial increase in manufacturing costs. Moreover, it would be advantageous if the winding arrangement were nicely balanced in order to limit recirculating currents in the stator during operation, and for the stator to have relatively low losses and high efficiency.

### SUMMARY

A stator for an electric machine is disclosed herein. In at least one embodiment, the stator comprises a stator core including a plurality of teeth with slots formed between the teeth. A winding arrangement is positioned on the stator core and includes a plurality of conductors forming a multi-phase winding. Each phase of the multi-phase winding includes a plurality of parallel paths arranged in the slots with the winding defined by at least four slots-per-pole-per-phase. The plurality of parallel paths include a first plurality of adjacent paths and a second plurality of adjacent paths, wherein the winding is void of any weave between the first plurality of adjacent paths and the second plurality of adjacent paths. Start leads and finish leads for the plurality of parallel paths are all positioned on a same half of the stator core.

In at least one embodiment, the winding arrangement of the stator includes a plurality of conductors forming a multi-phase winding on the stator core, wherein each phase of the multi-phase winding includes a plurality of parallel paths arranged in adjacent slot sets on the stator core with end turns extending between adjacent slot sets, and all of the end turns are configured as over-under end turns. Each of the plurality of parallel paths includes a first half-path connected in series to a second half-path. Each first half-path is formed by a primary length of continuous wire connected to a secondary length of continuous wire by a coupling. Each second half-path is formed by a single length of continuous wire.

In at least one embodiment, a method is disclosed for forming at least one phase of a multi-phase winding arrangement on a stator core, wherein the multi-phase winding arrangement includes a plurality of parallel paths. The method includes inserting a first plurality of half-paths in adjacent slot sets on the stator core with end turns extending between adjacent slot sets, wherein all of the end turns positioned along the first plurality of half-paths are over-under end turns, and wherein each of the first plurality of half-paths is formed by a primary length of continuous wire connected to a secondary length of continuous wire by a coupling. The method further includes inserting a second plurality of half-paths in adjacent slot sets on the stator core, wherein all of the end turns positioned along the second plurality of half-paths are over-under end turns, the second plurality of parallel half-paths formed by a single length of continuous wire. Additionally, the method includes connecting the first plurality of half-paths to the second plurality of half-paths such that start leads and finish leads for each of the plurality of parallel paths are formed on a same side of the stator core.

The above-described features and advantages, as well as others, will become more readily apparent to those of ordinary skill in the art by reference to the following detailed description and accompanying drawings. While it would be desirable to provide a stator for an electric machine that provides one or more of these or other advantageous features as may be apparent to those reviewing this disclosure, the teachings disclosed herein extend to those embodiments which fall within the scope of any eventually appended claims, regardless of whether they include or accomplish one or more of the advantages or features mentioned herein.

### BRIEF DESCRIPTION OF THE DRAWINGS

FIG. 1 shows a cross-sectional view of a first half (A side) of a stator with an S-winding arrangement;

FIG. 2 shows a cross-sectional view of a second half (B side) of the stator of FIG. 1 with the S-winding arrangement;

FIG. 3 shows a perspective view of an exemplary stator core configured to receive the winding arrangement of FIG. 1;

FIG. 4 is a tabular diagram showing the arrangement of conductors in slots of the stator core for one phase of the winding arrangement of the stator of FIG. 1;

FIG. 5 shows another side view of conductors for another embodiment of the winding arrangement of FIG. 1 illustrating the over-under end loop arrangement for all adjacent pairs of conductors in adjacent slot sets; and

FIG. 6 shows an exemplary coupling between the primary start leads and the secondary finish leads of the winding arrangement of FIGS. 1 and 4; and

FIG. 7 shows a side view of the conductors for another embodiment of the winding arrangement of FIG. 1, this embodiment illustrating a method of forming a primary length of continuous wire and a secondary length of continuous wire for each path of a first plurality of parallel paths, as well as a single length of continuous wire for each path of a second plurality of parallel paths.

### DESCRIPTION

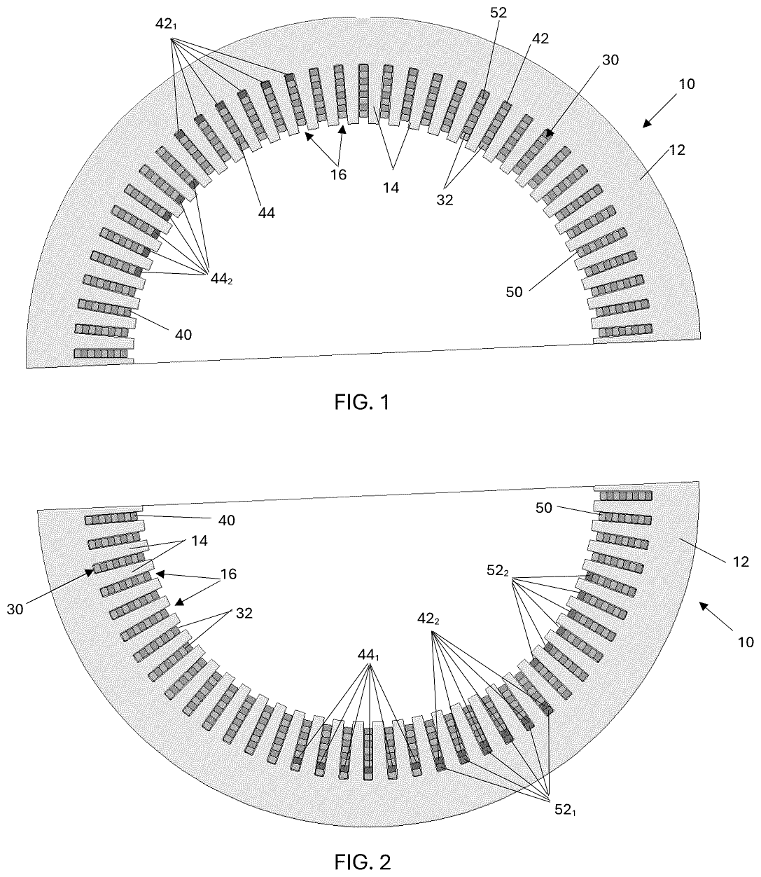

As shown in FIGS. 1 and 2, a stator 10 for an electric machine includes a stator core 12 with a winding 30 formed thereon. The winding 30 includes a plurality of conductors connected together to form a winding with multiple phases and multiple parallel paths in each phase. The winding 30 includes a plurality of parallel paths. Each path of the plurality of parallel paths is defined by conductors forming a first half-path and a second half-path. Each first half-path of a path is provided by a primary length of continuous wire connected to a secondary length of continuous wire. Each second half-path of the path is provided by at least one length of continuous wire. The conductors of the first half-path are connected in series to the conductors of the second half-path to form one complete path of the plurality of parallel paths. As will be recognized from the disclosure herein, the winding is void of any weaves between the parallel paths, or substantially void of any weaves between the parallel paths.

The following description of embodiments of the stator for an electric machine makes use of relative terms that are dependent on an orientation of the electric machine at a given time (e.g., during manufacture or use of the machine in a vehicle). Accordingly, it will be recognized that many terms of orientation and position as used herein are defined with reference to what may be shown in the drawing and/or other common positions. While efforts have been made herein to reference portions of the electric machine with respect to non-changing features (e.g., “axial,” “radial” and “circumferential” directions and related positions of the stator), it will be recognized that other terms are relative terms that depend on the position of the electric machine. For example, the terms “top” (or “upper”), “bottom” (or lower), “left” or “right” may be used herein in association with what is shown in a drawing, but such positions may switch or change if the electric machine is placed in a different position. As another example, the term “above” references a relative position where one component is vertically higher than another component, and the term “below” references a relative position where one component is vertically lower than another component.

### Stator Core

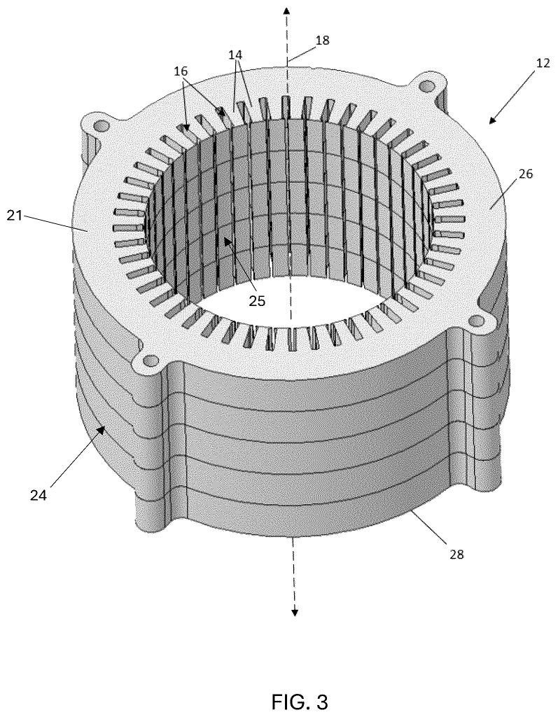

FIG. 3 shows a view of the stator core 12 in isolation from the winding 30. The stator core 12 is comprised of a ferromagnetic material and is typically formed from a plurality of sheets of magnetic-permeable material (e.g., steel, soft magnetic composite, or other appropriate material) that are stamped and stacked upon one another to form a lamination stack. The stator core 12 is generally cylindrical in shape as defined by a center axis 18, and includes an outer perimeter surface 24 and an inner perimeter surface 25. The outer perimeter surface 24 defines the outer diameter (OD) for the stator. The inner perimeter surface 25 defines the outer diameter (ID) for the stator.

A plurality of teeth 14 are formed on the interior of the stator core 12 and directed inwardly toward the center axis 18. Each tooth 14 extends radially inward from a back iron 21 and terminates at the inner perimeter surface 25. Axial slots 16 are formed in the stator core 12 between the teeth 14. Each slot 16 is defined between two adjacent teeth, such that two adjacent teeth form two opposing radial walls for one slot. The teeth 14 and slots 16 all extend from a first end 26 to a second end 28 of the core.

The slots 16 may be open or semi-closed along the inner perimeter surface of the stator core 12. When the slots 16 are semi-closed, each slot 16 has a width that is smaller at the inner perimeter surface than at more radially outward positions (i.e., slot positions closer to the outer perimeter surface). When the slots are open, conductors may be inserted into the slots from the ID. In addition to the radial openings to the slots 16 through the inner perimeter surface (i.e., for open and semi-closed slots), axial openings to the slots 16 are also provided the opposite ends 26, 28 of the stator core 12.

The stator core 12 is configured to retain the winding 30 (which may also be referred to as a “winding arrangement”) within the slots 16 of the stator core 12. The winding arrangement 30 is formed from a plurality of conductors that are retained within the slots 16. The conductors are formed of copper or other electrically conductive material that form in-slot portions and end-loops (which may also be referred to as “end-turns”) that extend between the in-slot portions and wrap around the teeth of the core.

### First Embodiment of Winding Arrangement

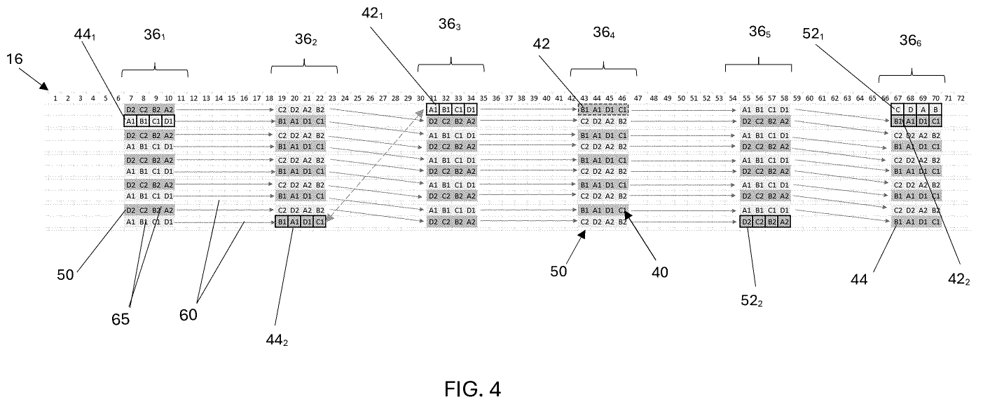

With reference again to FIGS. 1 and 2, the stator core 12 is shown with an embodiment of the winding arrangement 30 positioned on the stator core. The winding arrangement includes a plurality of conductors 32 forming a multi-phase winding on the stator core 12. The multi-phase winding includes a plurality of parallel paths arranged in the slots of the core. In the first embodiment, each of the plurality of parallel paths include a first half-path portion 40 of the path as illustrated by orange conductors in FIGS. 1 and 2, and a second half-path portion 50 of the path as illustrated by blue conductors in FIGS. 1 and 2. However, it will be noted that in other embodiments, each parallel path may be formed by two first half-path portions 40 or two second half-path portions 50 connected in series, as described in further detail below (i.e., under the heading “Other Embodiments of the Winding Arrangement”). It will be recognized that the “orange” and “blue” designations are merely for convenience in easily illustrating and distinguishing the different sets of parallel paths in the winding disclosed herein. In the embodiment of FIGS. 1 and 2, the winding is defined by two slots-per-pole-per-phase (all three phases are shown in FIGS. 1 and 2), but it will be recognized that a different number of slots-per-pole-per phase may be utilized in other embodiments (e.g., four slots-per-pole-per-phase such as that described in further detail below in association with FIG. 4).

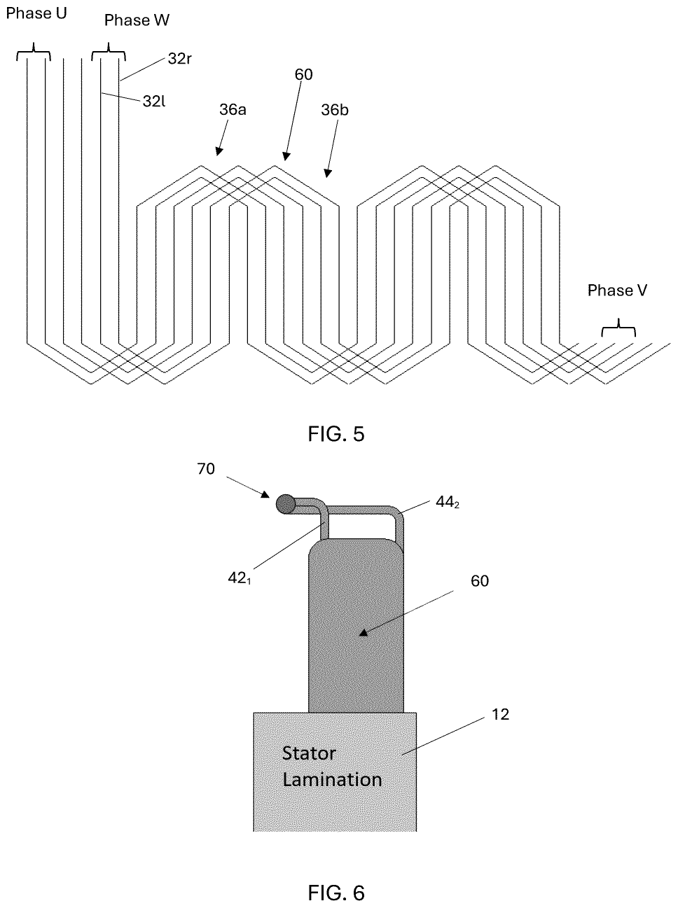

The winding 30 disclosed herein may be a “weave-less” (“weaveless”) design or a “substantially weaveless” winding arrangement. A “weaveless” winding arrangement is one that is void of any weaves between any of the parallel paths of the winding. A “substantially weaveless” winding arrangement is a winding that has only one or two weaves per phase (e.g., in order move leads to an outermost or inner most layer of the winding arrangement). A “weave” occurs in a winding when end turns of adjacent conductors cross one another in order to exchange slot order or layer order for the conductors between adjacent slot sets. Thus, a weave occurs when adjacent conductors in two successive layers of one slot set exchange layer positions (i.e., inward/outward) in the adjacent slot set. For example, a weave occurs when two left-right conductors in layer #1 of a first slot set move to layer #2 in the second slot set, and the left-right conductors in layer #2 of the first slot set move to layer #1 in the second slot set. This results in the need to weave the conductors such that the end turns cross one another between the slot sets. A “weave” will be distinguished from an “over-under” end turn arrangement. An exemplary “over-under” end turn arrangement is shown in FIG. 5. As shown in FIG. 5, the two left-right paths for one phase (e.g., conductors 32l and 32r for Phase W) never cross one another. Instead, when moving from one slot set to the next (e.g., from 36a to 36b), the over-under end turns 60 allow the two conductors to simply exchange positions between slot sets.

One exemplary embodiment of a stator with an S-winding is disclosed in U.S. Pat. No. 11,545,867, the entire contents of which is incorporated herein by reference. However, this S-winding results in leads on opposite sides of the stator core and requires the use of a busbar to connect leads on opposite sides of the stator core. In order to accomplish an S-wind with a weaveless design (or substantially weaveless design) as disclosed herein, over-under end turns such as those shown in FIG. 5 are utilized. Additionally, each first half-path 40 (i.e., orange path portions in FIGS. 1 and 2) is formed by two continuous lengths of wire and each second half-path 50 (i.e., the blue path portions in FIGS. 1 and 2) is formed by a single length of wire. A length of “continuous” wire is a length of wire that does not include a coupling (e.g., a weld, bond or other mechanical connection) other than the wire itself. Additionally, the term “half-path” as used herein references a portion of path that is extends at least from one of the two outermost layers to one of the two innermost layers of the winding arrangement, and is not limited to a length of conductor that is exactly half the length of the path.

With continued reference to FIGS. 1 and 2, each first half-path 40 (i.e., the orange path portions) is formed by a primary length of continuous wire 42 and a secondary length of continuous 44 wire that are connected at their ends to form one complete first half-path 40. The primary length of continuous wire 42 for each orange path portion is relatively short in comparison to the secondary length of continuous wire 44. The primary length of continuous wire 42 begins in the outermost layer of the slots (i.e., layer #1) on a first half of the stator core as shown as shown by primary start leads 42₁ in FIG. 1 (the half of the stator core shown in FIG. 1 may be referred to herein as “Side A” of the stator core). From there, the primary length of continuous wire 42 wraps partially around the stator core—to an opposite/second half of the stator core—and terminates in the second layer of the slots (i.e., layer #2) as shown by primary finish leads 42₂ in FIG. 2. Accordingly, the primary length of continuous wire 42 does not even make one complete wrap around the stator core 12 and particularly makes approximately ½ of a wrap around the stator core.

The secondary length of continuous wire 44 for each orange path portion begins in the second layer of the slots on the opposite/second half of the stator core as shown by secondary start leads 44₁ in FIG. 2 (the half of the stator core shown in FIG. 2 may be referred to herein as “Side B” of the stator core, which is 180° opposite Side A). From there, the secondary length of continuous wire 44 wraps around the stator core multiple times until it terminates in the innermost layer of the slots (i.e., layer #8) as shown by secondary finish leads 44₂ in FIG. 1. The number of wraps between the secondary start leads 44₁ and the secondary finish leads 44₂ is generally N−0.5, where N is the desired number of wraps for the machine and the 0.5 is the half wrap associated with the primary length of continuous wire 44. As will be recognized by those of skill in the art, the desired number of wraps is a significant factor in determining the number of electrical turns and for determining the torque-speed curve of the motor.

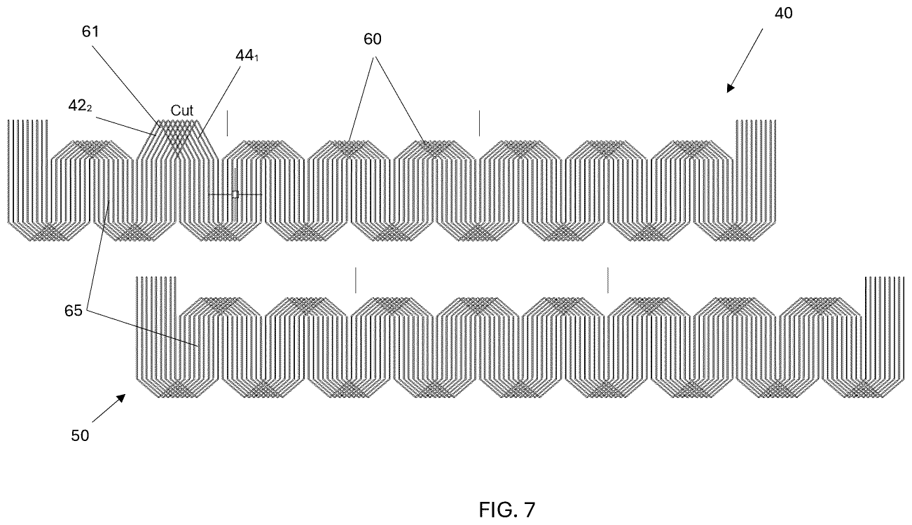

In order to complete each first half-path 40, the finish leads 44₂ of the secondary length of continuous wire 44 are connected to the start leads 42₁ of the primary length of continuous wire 42, thus providing a series connection between the primary length of continuous wire 42 and the secondary length of continuous wire 44. This connection is made by a coupling 70 between the leads 42₁ and 44₂ that is above and/or radially outward from the end turns 60 of the winding arrangement 30. An exemplary connection between the primary length of continuous wire 42 and the secondary length of continuous wire 44 is illustrated in FIG. 6. As shown in FIG. 6, the leads 42₁ and 44₂ extend above (i.e., axially outward from) the end turns 60, and a physical and electrical connection between the leads 42₁ and 44₂ is made radially outward and axially outward from the end turns 60. This connection is made by a coupling 70, such as a weld coupling that joins the leads 42₁ and 44₂ together. With this connection made, the finish leads 42₁ of the primary length of continuous wire 42 and the start leads 44₁ of the secondary length of continuous wire 44 serve as the leads to each first half-path 40. Accordingly, it will be noted that each first half-path 40 is formed by two different continuous wires 42, 44 that are connected together to form the half-path (the orange path portion).

With continued reference to FIGS. 1 and 2, the second plurality of half-paths 50 are differently configured than the first plurality of half-paths 40. In contrast to the first plurality of half-paths 40 (orange path portions), each of the second plurality of half-paths 50 (blue paths) is formed by only a single length continuous wire 52. The length of continuous wire 52 for each blue path portion begins in the outermost layer of the slots (i.e., layer #1) on a first half of the stator core as shown by start leads 52₁ in FIG. 2. From there, the primary length of continuous wire 52 wraps around the stator core multiple times and terminates in the innermost layer (i.e., layer #10) of the slots (i.e., slot set 36₅) as shown by finish leads 52₂ in FIG. 2.

The first half-paths 40 and the second half-paths 50 are connected together in in order to form each of the plurality of parallel paths for the winding. In particular, primary finish leads 42₂ of the first half-paths 40 are connected in series to an associated start leads 52₁ of the second half-paths 50. As a result, it will be recognized that the start leads for at least some of the plurality of parallel paths of the winding 30 are provided by the secondary start leads 44₁ of the first-half paths 40 and the associated finish leads are provided by the finish leads 52₂ of the second half-paths 50.

The disclosed winding design shown in FIGS. 1 and 2 provides a winding arrangement wherein start leads and finish leads for the plurality of parallel paths of the winding are all positioned on a same half of the stator core. The term “half” of a stator core/winding as used herein refers to a portion of the stator core that spans an arc of 180°. For example, as shown in FIG. 2, all of the start leads and finish leads for the plurality of parallel paths of the winding 30 are on the same half of the winding because each of leads 44₁ and 52₂ can be seen in the half of the stator shown in FIG. 2. Furthermore, it will also be noted that all of the connections between the first half-paths (orange leads 42₂) and the second half-paths (blue leads 52₁) are all positioned in the two backmost layers and the two frontmost layers on this same half of the stator core.

### Second Embodiment of Winding Arrangement

With reference now to FIG. 4, an alternative embodiment of the winding 30 is shown on a slot graph illustrating one phase of the winding. This embodiment of the winding is arranged on a stator core 12 similar to that described above in association with FIGS. 1 and 2, but with some differences. Similar to the winding of FIGS. 1 and 2, the winding illustrated in FIG. 4 includes a plurality of parallel paths (i.e., paths A-D) wherein each parallel path includes a first half-path 40 (shown in orange in FIG. 4) and a second half-path 50 (shown in blue in FIG. 4). The first half-paths 40 may also be referred to herein as the “orange path portions” and the second half-paths 50 may also be referred to herein as the “blue path portions.” The set of orange path portions 40 includes four path portions identified as paths A1, B1, C1 and D1. The set of blue path portions includes four path portions identified as paths A2, B2, C2 and D2. Similar to the embodiment of FIGS. 1 and 2, each orange path portion 40 in the embodiment of FIG. 4 is formed by two lengths of consecutive wire 42, 44 (i.e., a primary length of consecutive wire 42 and a secondary length of consecutive wire 44), and each blue path portion 50 is formed by a single length of continuous wire 52. Unlike the winding arrangement in the embodiment of FIGS. 1 and 2, the winding arrangement 30 in the embodiment of FIG. 4 includes six poles with four slots-per-pole-per phase, and ten layers in each slot.

The slot graph of FIG. 4 illustrates the slots 16 associated with each pole/slot set 36 of the winding arrangement (i.e., slot sets 36₁-36₆) and the positions of the conductors in each slot. The slots 16 associated with a pole are also referred to herein as a “slot set” 36 for the associated pole and phase of the electric machine. For the sake of simplicity, FIG. 4 only shows the slot sets for a single phase of the winding arrangement.

The slot graph of FIG. 4 shows the particular path portion (i.e., A1-D1 of the orange path portions 40 or A2-D2 of the blue path portions 50) associated with each layer of each slot. As can be seen in FIG. 4, this embodiment of the winding arrangement includes ten layers of conductors in each slot with half of the layers filled with conductors from the orange path portions 40 and half of the layers filled with conductors from the blue path portions 50. The arrows extending between the slot sets represent sets of end loops 60 extending between the slot sets. It will be recognized that each of slot sets 36₁-36₆ includes two adjacent slot sets (i.e., a left slot set and a right slot set on either side of a given slot set). While the stator core 22 is shown as linear in FIG. 4 for the sake of convenience, it will be appreciated that the stator core 22 is actually annular, and therefore slots sets 36₁ and 36₆ are also adjacent slot sets. Although arrows are not shown in FIG. 4 extending from slots set 36₆ to 36₁, it will be recognized that end turns 60 also connect conductors in the same layers of these adjacent slot sets.

As shown in FIG. 4, each slot set 36 is comprised of four slots with ten layers in each slot and conductors of a single phase of the winding 30 in each slot (including five conductors from the orange path portions and five conductors from the blue path portions). Also, each layer of the slot set only includes conductors from either the orange path portions or the blue path portions, but not both. For example, layer #1 of slot set 36₂ only includes conductors from the blue parallel paths (i.e., conductors A₂-D₂), and layer #2 of the slot set 36₂ only includes conductors from the orange parallel paths (i.e., conductors A₁-D₁).

With continued reference to FIG. 4, it will be recognized that each set of parallel paths for the winding arrangement 30 includes pairs of “adjacent parallel paths” that are always located in the same layer of adjacent slots (which may also be referred to herein as simply “adjacent paths”). For example, parallel paths A and B are adjacent paths (i.e., “adjacent parallel paths A1-B1,”) because each instance of an “A” in a layer of a slot 16 includes an instance of “B” in the same layer of an adjacent slot. This is true for both the orange path portions (i.e., A1-B1) and the blue path portions (i.e., A2-B2) of the parallel path. Therefore, the orange path portions 40 include two pairs of adjacent paths (i.e., A1-B1 and C1-D1) and the blue path portions 50 also include two pairs of adjacent paths (i.e., A2-B2 and C2-D2).

In addition to adjacent parallel paths being defined by two paths that are always located in the same layers of adjacent slots, adjacent parallel paths also exchange slot positions with each successive slot set. For example, path portions A1 and B1 are always found in the same layer of a given slot set, but the position of path portions A1 and B1 switch left and right positions with each successive slot set (e.g., path portion A1 is in the left position and path portion B1 is in the right position of layer #3 in slot set 36₅, but path portion A1 is in the right position and path portion B1 is in the left position of layer #4 in slot set 36₆). This switching of slot positions for adjacent paths in successive slot sets is accomplished with only the use over-under end turns, similar to those shown in FIG. 5 described above. In view of these over-under end turns, a position of the first parallel path relative to the second parallel path alternate at successive adjacent poles for an entirety of the first parallel path and the second parallel path. Furthermore, in view of the over-under end turns and the unique configuration of different lengths of continuous wire to form the respective half-paths 40 and 50 for each of the parallel paths of the winding arrangement 30, it will be recognized that the winding arrangements 30 disclosed herein are formed without the need for any weaving of conductors between the parallel paths of the winding arrangement.

FIG. 4 further includes a number of black boxes that surround conductors in specific layers of specific slot sets. These black boxes indicate that there is a termination in the continuous conductors for the parallel paths at this slot. The terminations of the continuous conductors provide either phase leads, neutral leads, or in-path coupling points (i.e., series connections within a path) for the conductors. For example, in FIG. 4, the black boxes around the conductors in layer #2 and slot #s 9 and 10 of slot set 36₁ (i.e., the leads circled in red in slot set 36₁) may serve as power leads for parallel paths C and D of the winding. Similarly, the black boxes around the conductors in layer #10 and slot #s 57 and 58 of slot set 36₅ (i.e., the leads circled in red in slot set 36₅) may serve as power leads for parallel paths A and B of the winding (e.g., for a wye winding or a delta winding). The black boxes around the conductors in layer #s 1 and 2 of slot #s 67 and 68 (i.e., the leads circled in red in slot set 36₆) may serve as neutral leads for each of parallel paths A, B, C and D of the winding. The remaining black boxes in slot sets 36₁, 36₅ and 36₆ are used as leads that connect first half-paths (orange) to second half paths (blue). To connect half-path A1 (orange) to half-path A2 (blue), the lead A1 (orange) in layer #2 of slot #7 is connected to the lead A (blue) in layer #1 of slot #69. To connect half-path B1 (orange) to half-path B2 (blue), the lead B1 (orange) in layer #2 of slot #8 is connected to the lead B (blue) in layer #1 of slot #70. These series connections could be made by a reverse twist or other appropriate connection method. To connect half-path C1 (orange) to half-path C2 (blue), the lead C1 (orange) in layer #2 of slot #70 is connected to the lead C2 (blue) in layer #10 of slot #56. To connect half-path D1 (orange) to half-path D2 (blue), the lead D1 (orange) in layer #2 of slot #69 is connected to the lead D2 (blue) in layer #10 of slot #55. These series connections may be made by a connection similarly described in association with FIG. 6 wherein the leads extend above the end turns 60, and a physical and electrical connection between the leads is made radially outward and axially outward from the end turns.

In addition to the above, the black boxes around the conductors in layer #10 of slot set 36₂ (i.e., slot #s 19-22) and layer #1 of slot set 36₃ (i.e., slot #s 31-34) are internal path leads that are connected with four respective couplings (e.g., four welds) in order to provide series connections between the primary lengths of continuous wire 42 and secondary lengths of continuous wire 44 within the orange path portions. With this connection arrangement, it will be recognized that the S-wind includes all leads to the winding arrangement on one half of the stator core. Specifically, the power and neutral leads are all located in consecutive slot sets 36₁, 36₅ and 36₆ in the embodiment of FIG. 4.

As noted previously, FIG. 4 includes a series of arrows to illustrate the end-turn connections 60 between the in-slot portions 65 of each set of parallel paths (i.e., the orange path portions 40 and the blue path portions 50). By following the arrows, it can be seen that the four orange path portions 40 (noted by paths A1-D1) and the four blue path portions 50 (noted by paths A2-D2) each make five clockwise revolutions around the core 12 from the outermost layer to the innermost layer of the stator core 12. The term “revolution” as used refers to a wrap of the conductors substantially around and through the slots of the stator core even if the winding does not completely encircle the stator core a full 360° (e.g., a parallel path that wraps 345° around the stator core is considered to makes a revolution of the stator core even though it may not completely encircle the stator core a full 0° for some reason, such the parallel path ending in leads).

An exemplary winding progression for two adjacent parallel paths of the plurality of parallel paths will now be described with reference to adjacent paths C-D. Adjacent paths C-D are one of two adjacent paths of the winding arrangement of FIG. 4, the other adjacent paths being paths A-B. The power leads/start leads for the adjacent paths C-D in FIG. 4 are the leads identified by reference numeral 44₁ in layer #2 of slot #s 9 and 10. The neutral/finish leads for adjacent paths C-D are the leads identified by reference numeral 52₁ in layer #1 of slot #s 67 and 68.

Progression for the adjacent path C-D is described starting at leads 44₁ of the orange path portion 40 of FIG. 4. After entering the stator core at layer #2 of slot #s 9 and 10 (i.e., the power leads), the conductors for adjacent paths C1-D1 progress to successive slot set 36₂. As discussed previously herein, the end turns of the winding 30 are over-under end turns that flip the position of paths C1 and D1 between the two slot sets 36₁ and 36₂ (i.e., path C1 moves from a left position in slot set 36₁ to a right position in slot set 36₂ and path D1 moves from a right position in slot set 36₁ to a left position in slot set 36₂). The adjacent paths C1-D1 then flip positions again and move radially inward between slot sets 36₂ and 36₃. Adjacent paths C1-D1 then continue in a wave-like manner, flipping in successive slot sets and periodically moving inwardly one layer until reaching layer #10 of slot set 36₂.

At layer #10 of slot set 36₂, a connection is made between the internal leads of the orange path portions 40. These internal leads are identified in FIG. 4 as leads 44₂ and 42₁. Specifically, the leads 44₂ are associated with the conductors in layer #10 of slot set 36₂ (i.e., slot #s 21-22) and the leads 44₁ are associated with the conductors in layer #1 of slot set 36₃ (i.e., slot #s 33-34). The connection between the internal leads is illustrated in FIG. 4 by a red dotted line that extends between layer #10 of slot set 36₂ and layer #1 of slot set 36₂. These leads 44₂ and 42₁ are connected for path C1-D1 with two respective couplings (e.g., two welds). These couplings provide series connections for adjacent paths C1-D1. This series connection is a unique connection that spans over the top of the other end turns 60 between slot sets 36₂ and 36₃ and connects the conductors in layer #10 (near the ID) to those in layer #1 (near the OD). As discussed previously herein, FIG. 6 shows an illustration of an exemplary embodiment of such a connection. It will be recognized that the progression of adjacent paths C1-D1 to this point have been associated with two of the secondary lengths of continuous wire 44, and this series connection provides a connection between the secondary lengths of continuous of wire 44 and the primary lengths of continuous wire 42.

With continued reference to FIG. 4, after reaching slot set 36₃, the adjacent paths C1-D1 continue to wind through the stator core with the primary length of continuous wire 42. This primary length of continuous wire 42 is relatively short compared to the secondary length of continuous wire 44, and only completes approximately ½ a revolution around the stator core until terminating at leads 42₂ in layer #2 of slot set 36₆. This completes the progression of the first half-paths (C1-D1) of adjacent parallel paths C-D through the stator core. It will be recognized that the primary length of continuous wire 42 is arranged exclusively within two outermost layers of the slots (or in some alternative embodiments, within the two innermost layers of the slots), and the secondary length of continuous wire 44 is arranged in all layers of the slots.

At slot set 36₆, the first half-paths (C1-D1) of adjacent parallel paths C-D are connected in series to the second half-paths (C2-D2) of adjacent parallel paths C-D. As noted previously, the connection between C1 and C2 and the connection between D1 and D2 are provided between slot set 36₆ (layer #2) and slot set 36₅ (layer #10).

Adjacent half-paths C2-D2 (blue path portions) also traverse a similar winding path around the stator core as that described above for adjacent half-paths C1-D1. Specifically, adjacent half-paths C2-D2 start in layer #1 of slot set 36₆ (i.e., the neutral leads C and D which extend from slot #s 67 and 68 of the stator core) and end in layer #10 of slot set 36₅ (where half-path C2 is connected to half-path C1 and half-path D2 is connected to half-path D1). Unlike half-paths C1-D1 which are each formed from two distinct lengths of continuous wire 42, 44, half-paths C2-D2 are each formed from a single length of continuous wire 52.

The above-described progression is illustrative of one set of adjacent parallel paths of the winding 30. Adjacent paths A-B traverse a similar winding path around the stator core, the orange path portions 40 being formed from a primary length of continuous wire 42 and a secondary length of continuous wire 44, and the blue path portions 50 only formed from a single length of continuous wire 52. Adjacent paths A-B enter the stator core at the neutral leads in layer #2 of slot set 36₆ and then exit the stator core at the power leads at layer #10 of slot set 36₅.

### Other Embodiments of the Winding Arrangement

While two exemplary embodiments of the winding arrangement 30 have been described above, it will be recognized that numerous other winding arrangements are possible. For example, different connections may be made between the leads of the winding 30 shown in the slot diagram of FIG. 4 in order to configure the winding in a slightly different manner. In the second embodiment of the winding arrangement disclosed above, the orange half-paths are connected in series with the blue half-paths (e.g., A1 (orange) connected to A2 (blue), B1 (orange) connected to B2 (blue), etc.). However, in one configuration of the winding arrangement, two of the same-color half-paths are connected in series to form one of the parallel paths. For example, A1 (orange) is connected to C1 (orange), B1 (orange) is connected to D1 (orange), A2 (blue) is connected to C2 (blue), and B2 (blue) is connected to D2 (blue). This is accomplished with similar power and neutral leads to those shown in FIG. 4 (as noted by the red circles), but the connections between the half-paths are different. Specifically, the following connections are made: (i) half-path A1 at layer #2 of slot #7 is connected to half-path C1 at layer #2 of slot #70; (ii) half-path B1 at layer #2 of slot #8 is connected to half-path D1 at layer #2 of slot #69; (iii) half-path A2 at layer #1 of slot #69 is connected to half-path C2 at layer #10 of slot #56; and (iv) half-path B2 at layer #1 of slot #70 is connected to half-path D2 at layer #10 of slot #55.

Another example of a possible embodiment of the winding arrangement 30 involves the use of an added weave between slot sets 36₁ and 36₂. Such a weave would be advantageous in order to move the leads in slot set 36₁ from layer #2 to layer #1 (i.e., the outermost layer). By moving the leads to layer #1, the leads may be easily connected over the back iron of the core.

In yet another example of a possible embodiment of the winding arrangement 30, the orange paths and the blue paths are all connected in parallel (i.e., for a total of eight parallel paths).

### Method of Forming a Weaveless S-Winding

A method of forming an S-wind weaveless design is now disclosed in association with FIGS. 1, 2 and 7. The method includes a number of steps as outlined in the following paragraphs.

The method includes inserting both the first half-paths 40 (orange path portions) and the second half-paths 50 (blue path portions) of the plurality of parallel paths of the winding 30 on the stator core. As discussed herein, each of the first half paths 40 include both the primary length of continuous wire 42 and the secondary length of continuous wire 44. The primary length of continuous wire 42 is inserted in the outermost layers of the slots first. When the primary length of continuous wire 42 is inserted on the stator core 12, the primary start leads 42₁ are located on one side of the stator (e.g., side A as shown in FIG. 1), and the primary finish leads 42₂ are located ½ half wrap later on the opposite side of the stator (e.g., side B as shown in FIG. 2). As a result, the primary finish leads 431 are 180° (or almost 180°) separated from the primary start leads 42₁, and the number of wraps between the primary start leads and the primary finish leads is 0.5.

After each primary length of continuous wire 44 is inserted on the core 12, each secondary length of continuous wire 44 is wrapped around the stator core several times. The secondary start leads 44₁ are located in an adjacent slot set to the primary finish leads 42₂ (e.g., on side B of the stator) and are in a second layer of the slots. After the secondary length of continuous wire 44 is wrapped around the stator, the secondary finish leads 44₂ are positioned in the innermost layer in a slot set adjacent to the primary start leads 42₁ (e.g., on side A of the stator). The number of wraps between the secondary start leads 44₁ and secondary finish leads 44₂ is N−0.5 where N is the desired number of wraps for the machine. The desired number of wraps is a significant factor in determining the number of electrical turns in the primary factor for determining the torque-speed curve of the motor.

After the secondary length of continuous wire 44 is provided on the stator core, the secondary finish leads 44₂ (e.g., on side A) are then connected to the primary start leads 42₁ (also on side A) by weld or some other connection means. For simplicity, this connection may be identified as the “Side A connection.” In at least one embodiment of the side A connection, such as that shown in FIG. 1, the primary start leads 42₁ exit the slots on the OD of the end loops and the secondary finish leads 44₂ exit the slots on the ID of the end loops. In order to reduce the height of the side A connection, the secondary finish leads 44₂ may be bent outward over the top of the end loops 60 and the primary start leads 42₁ may be bent outwards, as shown in FIG. 6. The coupling welds 70 are then radial welds. In at least one alternative embodiment, the primary start leads 42₁ bend inwards over the top of the end loops 60 and the secondary finish leads 44₂ also bend inwards. The leads then exit the core at the same angle as the common end loops, similar to the angle of the end loops shown in FIG. 5. This results in the primary start leads 42₁ and the secondary finish leads 44₂ ending in the same circumferential position. Once the Side A connection is made, this leaves the primary finish leads 42₂ (on side B) and secondary start leads 44₁ (also on side B) as the power leads for a delta winding and power/neutral leads for a Y winding.

At the same time as arranging the first half-paths 40 (orange paths) on the stator core 12, the second half-paths 50 (blue paths) are also arranged on the stator core 12. Each of the second half-paths 50 is formed by arranging a single length of continuous wire 52 on the core 12. This may be accomplished by inserting the start leads 52₁ on the second side (side B) of the stator, wrapping the single length of continuous wire 52 the desired number of wraps around the stator core 12, and then ending with the finish leads 52₂ on the second side (side B) of the stator. It will be noted that the second half-paths 50 are standard windings. For end loop nesting, the second half-paths 50 are electrically 180° offset from the first half-paths on the stator. Accordingly, at the same location in the stator, the end loops of the first half-paths 40 are on one axial end of the stator core 12 and the end loops of the second half-paths 50 are located on the opposite axial end of the core 12.

When the winding arrangement 30 is complete, it will be recognized that half of the conductors in the outermost layer of the winding (i.e., layer #1) are from the first-half path (orange path portion) and half of the conductors in the outermost layer are from the second-half path (blue path portion). This is best illustrated in FIG. 4 wherein only orange conductors are show in slot sets 36₃-36₅ and only blue conductors are shown in slot sets 36₆-36₂. After traversing half of the stator core, the orange conductors shift inwards to layer #2 for another half of the stator core (see slot sets 36₆ to 36₂ of FIG. 4). Similarly, the blue conductors also shift inwardly to layer #2 after traversing half of the stator core (see slot sets 36₃ to 36₅). This same pattern then repeats itself for further wraps around the stator and successive layers until the innermost layer is reached.

Advantageously, the above-described pattern eliminates the need to secondary weave the parallel wires as each parallel wire is located in layer #1 the same number times, layer #2 the same number of times and so forth. For the case where the number of poles (P) is a number where P/2=and odd number (such as P=6), side A and side B are not exactly 180 degrees form each other because P/2=odd number. Consequently, the above-mentioned formula of N−0.5 will be slightly different when P/2 is an odd number.

It will be recognized that in many prior art windings, the primary weave is typically required when multiple slots per pole per phase (SPPPP) require over-under end loops. These over-under end loops cause wire A to switch positions with wire B. For example, for a 2 SPPPP machine, in pole #1, wire A might be in the left slot and wire B is in the right slot. An over-under end loop is located between pole 1 and pole 2. Due to the over-under end loop, wire B will be located in the left slot and wire A in the right slot for pole 2. For an S-wind, for the wires to nest properly in the end loops, any point where the wires cross each other in the end loops, the wire on the left should always have end loops radially outward of the other wires on the right. So for the case of the over-under end loops, the leftmost wire changes from being wire A in pole 1 to wire B in pole 2. Therefore, these two wires need to be woven such that wire A is radially outward of wire B in pole 1 and poles counter-clockwise (CCW) from pole 1. Similarly, wire B will be radially outward of wire A in pole 2 and poles clockwise (CW) form pole 2. However, for the winding disclosed herein, and the associated method of forming the winding disclosed herein, the need for a primary weave is eliminated by eliminating areas where the wires cross each other in the end loops.

In at least one embodiment, a method for forming a four slots-per-pole-per-phase (4 SPPPP) winding is disclosed. The winding includes a first half of parallel paths 40 and a second half of parallel paths 50. As described herein, the first half of parallel paths 40 are arranged on the core 12 with wire A1 and wire B1 in alternate slots in the two left most slots of each pole with 100% over-under end loops, and wire C1 and wire D1 alternate slots in the two right most slots of each pole with 100% over under end loops. The second half of parallel paths 50 have wire A2 and B2 alternating in the right most two slots and C2 and D2 alternating slots in the left most two slots of each pole. Finally, a lead of wire A1 is connected in series with a lead of wire A2, a lead of wire B1 is connected in series with a lead of wire B2, a lead of wire C1 is connected in series with a lead of wire C2, and a lead of wire D1 is connected in series with a lead of wire D2. Wires A1, B1, C1, D1 are of primary type windings explained above.

With reference now to FIG. 7, in at least one embodiment, a method is disclosed for forming the first half-paths 40 for the winding 30 by severing one continuous length of wire and thereby forming the primary length of continuous wire 42 and the secondary length of continuous wire 44 for each path of the first half of parallel paths 40. As illustrated in FIG. 7, the method involves first forming the first half-paths 40 and the second half-paths 50, wherein a single length of continuous wire is used for each half-path. However, in order to form the primary length of continuous wire 42 and the secondary length of continuous wire 44 for the first half-path 40, one unique set of end turns 61 is made using end turns that are taller than all of the other end turns 60. Either after or before insertion into the stator core 12, this unique set of end turns 61 are cut/severed, thus splitting the length of continuous wire into two parts. This results in two additional sets of leads wherein end turns 61 were formerly positioned (i.e., the two additional sets of leads formed by the cut are primary finish leads 42₂ and secondary start leads 44₁ of the orange path portion). Accordingly, each first half-path 40 is now split into a primary length of continuous wire 42 and a secondary length of continuous wire 44. This provides each of leads 42₁, 42₂, 44₁, and 44₂, as described previously herein. Connections between these leads are then made in order to form the winding arrangement 30.

While each path of the winding arrangement 30 has been described herein as being formed from two or fewer continuous lengths of wire, it will be recognized that in other embodiments the winding 30 may be differently formed. For example, additional lengths of wire may be used to form the individual parallel paths of the winding. For example, individual sections of the winding 30 may be formed of segmented (i.e., non-continuous) lengths of wire (also known as “hairpins”) that are welded together at the end turns to form each of the plurality of parallel paths.

The foregoing detailed description of one or more embodiments of the method of making an electric machine have been presented herein by way of example only and not limitation. It will be recognized that there are advantages to certain individual features and functions described herein that may be obtained without incorporating other features and functions described herein. Moreover, it will be recognized that various alternatives, modifications, variations, or improvements of the above-disclosed embodiments and other features and functions, or alternatives thereof, may be desirably combined into many other different embodiments, systems or applications. Presently unforeseen or unanticipated alternatives, modifications, variations, or improvements therein may be subsequently made by those skilled in the art which are also intended to be encompassed by any appended claims. Therefore, the spirit and scope of any eventually appended claims should not be limited to the description of the embodiments contained herein.

What is claimed is:

1. A stator for an electric machine comprising:
a stator core including a plurality of teeth with slots formed between the teeth; and
a winding arrangement positioned on the stator core, the winding arrangement including a plurality of conductors forming a multi-phase winding on the stator core, each phase of the multi-phase winding including a plurality of parallel paths arranged in the slots, and wherein start leads and finish leads for the plurality of parallel paths are all positioned on a first half of the stator core;
wherein at least one of the plurality of parallel paths is formed by a first half-path connected in series with a second half-path, and the first half-path comprised of a primary length of continuous wire connected to a secondary length of continuous wire.

2. The stator of claim 1 wherein the second half-path is comprised of a single length of continuous wire.

3. The stator of claim 2 wherein a coupling connects the primary length of continuous wire connected to the secondary length of continuous wire, and the coupling is located on a second half of the stator core opposite the first half.

4. The stator of claim 3 wherein the coupling is a weld that connects the first length of continuous wire to the second length of continuous wire.

5. The stator of claim 3 wherein the first length of continuous wire and the second length of continuous wire are provided by a severed length of continuous wire that is severed at a sever point, wherein the sever splits the one length of continuous wire into the first length of continuous wire and the second length of continuous wire.

6. The stator of claim 5 wherein one side of the sever serves as a start lead for one of the plurality of parallel paths and a finish lead of one of the second half-paths serves as a finish lead for the said one of the plurality of parallel paths.

7. The stator of claim 3 wherein a finish lead for the primary length of continuous wire and a start lead of one of the second half-paths are connected together to serve as an internal series connection for one of the plurality of parallel paths.

8. The stator of claim 7 wherein a start lead for the primary length of continuous wire is connected to a finish lead for the secondary length of continuous wire.

9. The stator of claim 3 wherein the connection between the start lead for the primary length of continuous wire and the finish lead for the secondary length of continuous wire is provided by a weld coupling positioned axially over end turns of the winding on one side of the stator.

10. The stator of claim 1, the stator core defining an inner diameter (ID) and an outer diameter (OD), each slot of the stator core including a back portion closer to the OD and a front portion closer to the ID, wherein the winding arrangement includes at least four layers of conductors in each slot defining two backmost layers and two frontmost layers, and wherein the start leads and the finish leads for the plurality of parallel paths are all positioned in the two backmost layers and the two frontmost layers on a same half of the stator core.

11. The stator of claim 1 wherein the plurality of parallel paths include at least one set of adjacent paths including a first parallel path and a second parallel path, wherein a position of the first parallel path relative to the second parallel path alternate at successive adjacent poles for an entirety of the first parallel path and the second parallel path, and wherein all end turns positioned along the first path and the second path are configured as over-under end turns.

12. A stator for an electric machine comprising:
a stator core including a plurality of teeth with slots formed between the teeth; and
a winding arrangement positioned on the stator core, the winding arrangement including a plurality of conductors forming a multi-phase winding on the stator core, each phase of the multi-phase winding including at least two parallel paths arranged in adjacent slot sets on the stator core with end turns extending between adjacent slot sets, wherein all of the end turns are configured as over-under end turns, wherein each of the at least two parallel paths includes a first half-path connected in series to a second half-path, wherein each first half-path is formed by a primary length of continuous wire connected to a secondary length of continuous wire by a coupling.

13. The stator of claim 12, wherein the winding arrangement includes four slots-per-pole-per-phase, wherein each adjacent slot set includes a first pair of adjacent parallel paths and a second pair of adjacent parallel paths, and wherein all end turns positioned along the first pair of adjacent parallel paths and the second pair of adjacent parallel paths are configured as over-under end turns.

14. The stator of claim 12, the stator core defining an inner diameter (ID) and an outer diameter (OD), each slot of the stator core including a back portion closer to the OD and a front portion closer to the ID with the plurality of conductors arranged in layers in the slots, and wherein the primary length of continuous wire is arranged exclusively within two outermost layers or two innermost layers of the slots and wherein the secondary length of continuous wire is arranged in all layers of the slots.

15. The stator of claim 12, the winding arrangement defined by at least four slots-per-pole-per-phase, and wherein start leads and finish leads for the plurality of parallel paths are all positioned on a same half of the stator core.

16. The stator of claim 12 wherein each second half-path is formed by a single length of continuous wire.

17. The stator of claim 12 wherein each second half-path is formed by a primary length of continuous wire connected to a secondary length of continuous wire by a coupling.

18. A method of forming at least one phase of a multi-phase winding arrangement on a stator core, the multi-phase winding arrangement including a plurality of parallel paths, the method comprising:
inserting a first plurality of half-paths in adjacent slot sets on the stator core with end turns extending between adjacent slot sets, wherein all of the end turns positioned along the first plurality of half-paths are over-under end turns, wherein each of the first plurality of half-paths is formed by a primary length of continuous wire connected to a secondary length of continuous wire by a coupling;
inserting a second plurality of half-paths in adjacent slot sets on the stator core, wherein all of the end turns positioned along the second plurality of half-paths are over-under end turns; and
connecting the first plurality of half-paths to the second plurality of half-paths such that start leads and finish leads for each of the plurality of parallel paths are formed on a same side of the stator core.

19. The method of claim 18, the second plurality of half-paths formed by a single length of continuous wire, wherein the primary length of continuous wire is at least half the length of the secondary length of continuous wire, and wherein the primary length of continuous wire is arranged in outermost slots of the stator core, and wherein the secondary length of continuous wire is arranged in all slots of the stator core.

20. The method of claim 18 wherein a start lead of the primary length of continuous wire is connected to a finish lead of the secondary length of continuous wire, and wherein the primary length of continuous wire and the secondary length of continuous wire is formed by severing an end turn to form a finish lead of the primary length of continuous wire and a start lead of the secondary length of continuous wire.
